(19) United States
(12) Patent Application Publication
(10) Pub. No.: US 2019/0235501 A1
(43) Pub. Date: Aug. 1, 2019

(54) SYSTEM AND METHOD FOR IDENTIFYING VEHICLE DELIVERY LOCATIONS UTILIZING SCOUT AUTONOMOUS VEHICLES

(71) Applicant: Walmart Apollo, LLC, Bentonville, AR (US)

(72) Inventors: Robert CANTRELL, Herndon, VA (US); Nathan JONES, Bentonville, AR (US)

(73) Assignee: Walmart Apollo, LLC, Bentonville, AR (US)

(21) Appl. No.: 16/264,269

(22) Filed: Jan. 31, 2019

Related U.S. Application Data
(60) Provisional application No. 62/624,734, filed on Jan. 31, 2018.

(51) Int. Cl. G05D 1/00; G05D 1/10; G06Q 10/08; G08G 5/00; G08G 5/02

(52) U.S. Cl. CPC G05D 1/0088; G05D 1/101; G06Q 10/08355; G01C 5/005; G08G 5/025; G05D 2201/0207; G08G 5/0069

(57) ABSTRACT

Methods and systems for identifying delivery locations utilizing scout autonomous vehicles are provided. An example method can include: identifying locations associated with a plurality of delivery locations having addresses stored at a database; filtering the locations to identify a first set of delivery locations; assigning a confidence level to each of the first set of delivery locations; identifying a second set of delivery locations in high confidence landing zones using a geo-spatial data; instructing the scout autonomous vehicle to reconnoiter locations of the second set of the delivery locations having a high confidence level, wherein the scout autonomous vehicle is configured to: record still images and videos of the locations of the second set of the delivery locations; analyze the still images and videos to determine a third set of delivery locations; and suggest landing zones at locations of the third set of the delivery locations.

### CROSS-REFERENCE TO RELATED APPLICATION

This application claims the benefit of U.S. Provisional Patent Application No. 62/624,734, filed Jan. 31, 2018, which is incorporated herein by reference in its entirety.

### TECHNICAL FIELD

The present disclosure relates to scout autonomous vehicles, and more specifically to scout autonomous vehicles for identifying delivery locations for unmanned vehicles.

### BACKGROUND

Autonomous ground vehicles (AGV) or unmanned aerial vehicles (UAVs) (e.g. drones) are generally vehicles that operate without a human pilot aboard. Drones can be used for performing surveillance, reconnaissance, and exploration tasks for military and civilian applications. The use of drones for package delivery has become more prevalent in society.

Existing drone delivery programs are generally based on customers seeking out and opting into the drone delivery programs. A wide variety of the potential customers may not utilize the delivery programs because of lack of information, especially potential delivery locations. Therefore, there is a need to identify potential drone delivery locations.

### SUMMARY

An example method of performing concepts disclosed herein can include: under control of a computing device configured with executable instructions: identifying locations having addresses stored at a database; filtering the locations to identify a first set of delivery locations, the first set of the delivery locations being on or near to an existing or planned drone delivery route; assigning a confidence level to each of the first set of delivery locations based on customer purchase history, residence yard clearance status and drone delivery routes; identifying a second set of delivery locations in high confidence landing zones using a geo-spatial data, the second set of the delivery locations not currently used for a drone delivery program; instructing a scout autonomous vehicle equipped with a sensor suite to reconnoiter locations of the second set of the delivery locations having a high confidence level, wherein the scout autonomous vehicle is configured to: record still images and videos of the locations of the second set of the delivery locations; analyze the still images and videos to determine a third set of delivery locations; and suggest landing zones at the third set of the delivery locations based on an analysis of the still images and videos.

An example system configured according to the concepts and principles disclosed herein can include: a scout autonomous vehicle; a computing device comprising: at least one computer processor; and a memory coupled to the processor and storing program instructions that when executed by the processor and based on a sensor detection, cause the processor to perform operations comprising: identifying locations having addresses stored at a database; filtering the locations to identify a first set of delivery locations, the first set of the delivery locations being on or near to an existing or planned drone delivery route; assigning a confidence level to each of the first set of the delivery locations based on purchase history, residence yard clearance status and drone delivery routes; identifying a second set of delivery locations potentially resided in high confidence landing zones using a geo-spatial data, the second set of the delivery locations not currently used for a drone delivery program; instructing the scout autonomous vehicle equipped with a sensor suite to reconnoiter locations of the second set of the delivery locations having a high confidence level, the scout autonomous vehicle being configured to: record still images and videos of the locations of the second set of the delivery locations; analyze the still images and videos to determine a third set of delivery locations; and suggest landing zones at locations of the third set of the delivery locations based on an analysis of the still images and videos.

An example non-transitory computer-readable storage medium configured as disclosed herein can have instructions stored which, when executed by a computing device, cause the computing device to perform operations including: identifying locations having addresses stored at a database; filtering the locations to identify a first set of delivery locations, the first set of the delivery locations being on or near to an existing or planned drone delivery route; assigning a confidence level to each of the first set of delivery locations based on customer purchase history, residence yard clearance status and drone delivery routes; identifying a second set of delivery locations in high confidence landing zones using a geo-spatial data, the second set of the delivery locations not currently used for a drone delivery program; instructing a scout autonomous vehicle equipped with a sensor suite to reconnoiter locations of the second set of the delivery locations having a high confidence level, wherein the scout autonomous vehicle is configured to: record still images and videos of the locations of the second set of the delivery locations; analyze the still images and videos to determine a third set of delivery locations; and suggest landing zones at the third set of the delivery locations based on an analysis of the still images and videos

Additional features and advantages of the disclosure may be set forth in the description which follows, and in part may be obvious from the description, or can be learned by practice of the herein disclosed principles. The features and advantages of the disclosure can be realized and obtained by means of the instruments and combinations particularly pointed out in the appended claims. These and other features of the disclosure may become more fully apparent from the following description and appended claims, or can be learned by the practice of the principles set forth herein.

### BRIEF DESCRIPTION OF THE DRAWINGS

Example embodiments of this disclosure are illustrated by way of an example and not limited in the figures of the accompanying drawings, in which like references indicate similar elements and in which:

FIG. 1 is a block diagram illustrating an example environment in which some example embodiments may be implemented;

FIG. 2 is a flowchart diagram illustrating an example process for identifying the vehicle delivery locations utilizing a scout autonomous vehicle in accordance with some example embodiments; and

FIG. 3 is a block diagram illustrating an example computer system in which some example embodiments may be implemented.

It is to be understood that both the foregoing general description and the following detailed description are example and explanatory and are intended to provide further explanations of the invention as claimed only and are, therefore, not intended to necessarily limit the scope of the disclosure.

### DETAILED DESCRIPTION

Various example embodiments of the present disclosure may be described in detail below with reference to the accompanying drawings. Throughout the specification, like reference numerals denote like elements having the same or similar functions. While specific implementations and example embodiments are described, it should be understood that this is done for illustration purposes only. Other components and configurations may be used without parting from the spirit and scope of the disclosure, and can be implemented in combinations of the variations provided. These variations shall be described herein as the various embodiments are set forth.

In order for items to be delivered via drone, there should be a suitable location for the drone to land or otherwise delivery the item. Systems, methods, and computer-readable storage media provided in this disclosure are capable of identifying potential locations where a drone may deliver an item by utilizing scout autonomous vehicles.

In some example embodiments, the system may identify a set of potential drone delivery locations by filtering known locations having addresses. Based on pre-defined criteria, the system may assign a confidence level to each of the potential drone delivery locations. The confidence level represents the ability to successfully deliver a package to the delivery location.

The term “customer,” as used herein, is broadly referred to people who have placed, are placing, and/or may place orders via a merchant's website or a mobile application in the past, present, and future. The term “residence,” as used herein, is broadly referred to one or more residential and delivery addresses designated by a customer to receive ordered items, including customer residence, customer business location, home, other institutions, etc. The term “confidence level,” as used herein, is broadly referred to a particular level of drone delivery that a drone may be able to successfully deliver a package to a customer delivery location. The term “landing zone,” as used herein, is broadly referred to an area as a delivery location with a high probability or confidence level where the drone can have ample position coordinate (X, Y, and Z) clearance to drop off a package.

In some example embodiments, a scout autonomous vehicle may reconnoiter drone routes and potential delivery locations having a high confidence level of drone delivery. The scout autonomous vehicle may be outfitted with cameras, Lidar sensors and other sensors to capture and record still images and videos along navigation routes. The scout autonomous vehicle may apply a set of pre-defined criteria to analyze captured arrays of sensor data of the delivery location.

In some example embodiments, the scout autonomous vehicles may apply a set of pre-defined criteria to determine if a location is suitable for drone delivery. The scout autonomous vehicles may have pre-defined algorithmic models in place of what “good” landing zones look like. The scout autonomous vehicles may also have the capability to perform real-time analysis with an increased on-board sensor payload.

In some example embodiments, scout autonomous vehicles may fly over current heavily flown delivery routes, and then deviate off the typical route to locate potential delivery locations and landing zones. For example, the scout autonomous vehicle may be sent to record still images and videos along pre-defined traffic routes. The scout autonomous vehicle may then analyze captured arrays of sensor data received by scout autonomous vehicle sensors to identify drone delivery locations or landing zones. Utilizing the existing drone delivery routes may help to remove a level of complexity as obstacles on and around the existing route have already been mapped.

Based on the result of the real-time sensor data analysis, the scout autonomous vehicle may identify the potential locations for drone delivery service and provide or confirm a verification of a higher level of confidence that the delivery drone may be able to complete the delivery. The scout autonomous vehicle may also suggest or identify landing zones and take still images or videos of the potential landing zones.

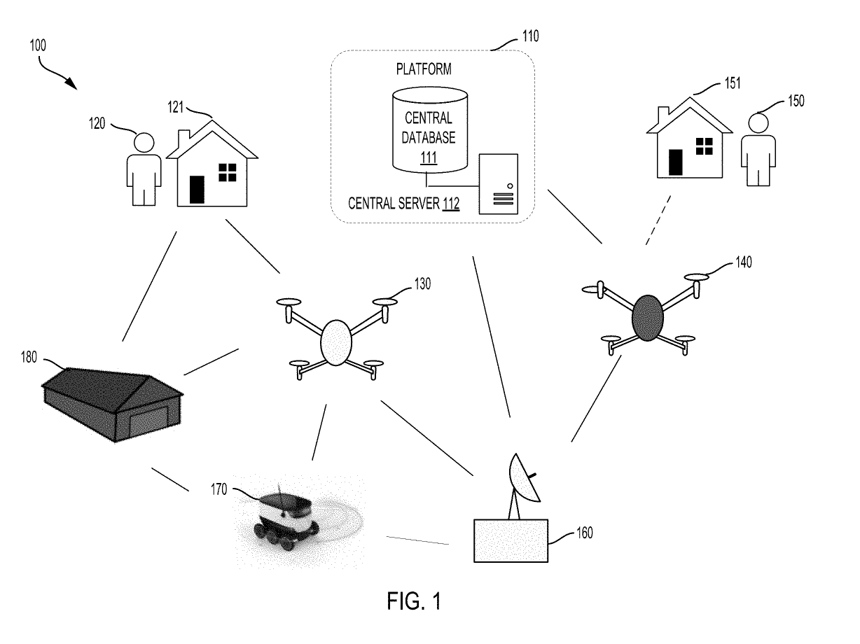

FIG. 1 is a block diagram illustrating an example environment 100 in some example embodiments may be implemented. The example environment 100 generally includes one or more of platform 110, customer 120, delivery drone 130, scout autonomous vehicle 140, customer 150, ground station 160, AGVs 170, and pickup site 180.

The platform 110 is a network-accessible computing platform and may be implemented as a computing infrastructure of one or more servers and databases including processors, memory (data storage), software, data access interface, and other components that are accessible via a mesh network and/or other wireless or wired networks. One or more servers are shown and referred to as central server 112 for simplicity, and one or more databases are shown and referred to as a central database 111 herein for simplicity. These servers may be include one or more processors and memory which may be utilized to operate a drone management system. The central database 111 may be communicatively coupled to the central server 112 to receive instructions or data from and send data to the central server 112 via network. Database 111 may record, store or otherwise contain therein geo-spatial data associated with customer profiles, drone delivery routes, products and/or services that are available for sale at an e-commerce website hosted on a web server and for delivering the customer orders by delivery drones to customer residential address or to a pickup site for picking up by the customer.

In the example environment 100, a network (not shown) may include satellite-based navigation system or a terrestrial wireless network, Wi-Fi, and other type of wired or wireless networks to facilitate communications between the various networks devices associated with example environment 100. The platform 110 may communicate with scout autonomous vehicles, delivery drones, AGVs, via the network for completing missions for delivering one or more products or conduct specific operations.

The drones (e.g., delivery drones 130, scout autonomous vehicles 140, etc.) may each include a communication system, which allows the drones to communicate with computing devices or processors in the environment 100 and with each other. The communication system may utilize cellular, radio frequency, near field communication, infrared, Bluetooth, Wi-Fi, satellite, or any other means for communication. The drones also includes one or more visual sensors, proximity sensors, and other types of sensors. These visual sensors and proximity sensors may be placed on one or more surfaces of the drones. The drones may also include GPS and one or more processors, which may determine positioning information for drones and conduct specific functions or data analysis.

The scout autonomous vehicle 140 may have an onboard payload including video cameras, or infrared cameras with visual and infrared spectra sensors, Lidar sensors, laser altimeter, or other types of sensors or sensing system. The scout autonomous vehicle 140 may be configured to have additional capabilities including recording and analyzing still images and videos of the likely delivery locations in real time. For example, the scout autonomous vehicle 140 may have a sensor suite capable of picking up obstacles, mapping out trajectories, and identifying the best landing zones or places to deliver a package. The scout autonomous vehicle 140 may analyze arrays of sensor data received by scout autonomous vehicle 140 sensors to identify drone delivery locations or landing zones. The scout autonomous vehicle 140 may also take pictures/video of the potential drone delivery landing zones to be shared with the customers.

Ground station 160 may coordinate drone package delivery by one or more delivery drones 130 and AGVs 170. The ground station 160 may include a local server and a local database with one or more processors and a communication system. For example, the ground station 160 may receive location information from the delivery drone 130 and AGVs 170 via a Global Positioning System (GPS), local positioning, mobile phone tracking, or other means. The ground station 160 may also receive drone delivery information from a delivery service, including mission details like a package destination, package origination location, package weight, and special instructions for handling of the package.

Customer 150 may create, via central server 112 and network, an account with platform 110 by creating a customer account profile to store personal information and credentials of customer in central database 111. Each account profile may be configured to store data related to customer information including customer's username, email address, password, phone number, customer's rating, delivery (residential) address (e.g., delivery location), landing zone, payment transaction accounts, purchasing preference, search history, order history, information, other relevant demographic or analytical data, third parties including family members, friends, or neighbors, etc. Central database 111 may be configured to store a plurality of account profiles.

Customer 120, already having an account, may place an online order of one or more items via the merchant's website or a mobile application for delivering to a delivery location 121 designated by the customer 120 using delivery drones. The drone landing zone information is associated with the customer who enrolls in the drone delivery program.

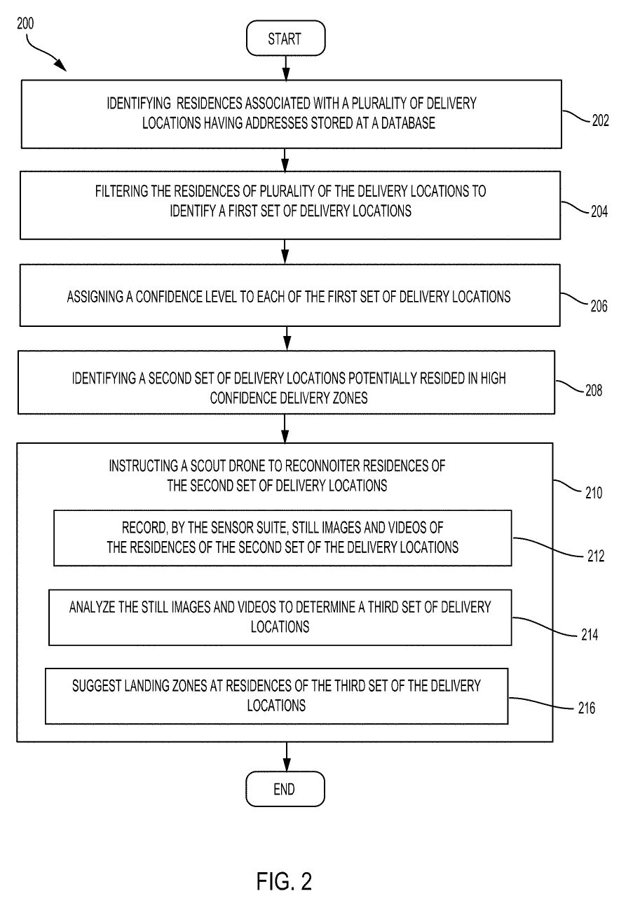

FIG. 2 is a flowchart diagram illustrating an example process 200 for identifying potential drone delivery locations utilizing a scout autonomous vehicle in accordance with some example embodiments. The process 200 may be implemented in the above described systems and may include the following steps. As should be understood, some of steps may be omitted, ordered or combined depending on the operations being performed.

In step 202, a processor at a platform may initially identify locations of a plurality of merchant's customers who have provided their addresses. The addresses maybe needed for delivery of ordered items, bill processing, etc. For example, referring to FIG. 1, the customers 120 may have created their accounts with associated account profile data stored in a database. Thus, the customers' locations can be obtained by the processor(s) accessing the customer account profiles. In some example embodiments, one or more backend subsystems may be used to obtain a wide variety geo-spatial data information to facilitate the data analysis in identifying drone delivery locations. The obtained data may be stored in one or more databases. The wide variety geo-spatial data may include: 1) satellite images or other high-resolution image data obtained from geo-spatial data sources; 2) geographic and location data or maps; 3) existing drone routes associated with drone delivery program; 4) existing drone route delivery locations; 5) specified radius from the nearest drone hub; 6) customer home addresses registered at merchant's website and or in other online programs.

In step 204, the processor may filter the locations to identify a first set of delivery locations that are on or near to an existing or planned drone delivery route. The locations may be of a plurality of existing customers. In some example embodiments, filtering locations of the first set may further include analyzing the stored geo-spatial data associated with existing drone routes, existing drone route delivery locations, specified radius from a nearest drone hub; and location of the existing customers. The processor(s) may also apply a pre-defined criteria to find the intersection of existing drone routes, model delivery location (e.g. yard with low levels of obstructions, near existing drone delivery locations) and delivery locations to identify a set of potential drone delivery locations.

In step 206, the system may assign a confidence level to each of the first set of delivery locations for being able to successfully deliver a package to the delivery locations. The confidence level may be assigned based on purchase history, delivery location status and existing or pending drone delivery routes.

In step 208, the variety of geo-spatial data, such as satellite images, may be used to identify a second set delivery locations in high confidence landing zones. As described above, the high confidence landing zones may be referred to an area as a delivery location with a high probability or confidence level where the drone can have ample position coordinate (X, Y, and Z) clearance to drop off a package. The second set of delivery locations may not be currently used for a drone delivery program.

In step 210, a scout autonomous vehicle 140 equipped with a sensor suite may be sent to reconnoiter the identified locations of the second set of delivery locations having a high confidence level. In some example embodiments, the process 200 may compare the assigned confidence level of each of the second set of locations with a pre-determined confidence level; and select the likely delivery locations based on a comparison when the assigned confidence level is higher or equal to the pre-determined confidence level. The pre-determined confidence level may be defined by a set of criteria corresponding to and be associated with a location suitable for drone delivery.

In step 212, the scout autonomous vehicle may be configured to record still images and videos of the locations of the second set of delivery locations. In some example embodiments, a geo-spatial data may be used to determine a second set of delivery locations. The geo-spatial data may be used to analyze at least one of satellite images or other high-resolution image obtained from geo-spatial sources and geographic location data or maps. The scout autonomous vehicles may also have the capability to perform real-time sensor data analyzation because of the increased sensor payload they have onboard.

In step 214, the scout autonomous vehicle may be configured to analyze the recorded still images and videos associated with the reconnoitered drone delivery routes and delivery locations such that a third set of the delivery locations can be determined based on the analyzed results. A set of pre-defined criteria may be applied to analyze arrays of sensor data returned from the scout autonomous vehicle. For example, the scout autonomous vehicles may process the recorded still images and videos by using pre-defined algorithmic models in place of what “good” landing zones look like. The scout autonomous vehicle may have a sensor suite capable of picking up obstacles, mapping out trajectories, and identifying the best places to deliver a package. Additionally, the scout autonomous vehicle may provide a verification of a higher level of confidence for the identified delivery locations and indicated the delivery drone may be able to complete the delivery at the delivery locations.

In step 216, the scout autonomous vehicle may suggest the landing zones at the third set of delivery locations based on an analysis of the recorded and analyzed still images and videos. A landing zone for each of the third set of delivery locations may be an area suggested as a delivery location with a high probability or confidence level where the drone can have ample position coordinate (X, Y, and Z) clearance to drop off a package. In some example embodiments, the scout autonomous vehicle may document the landing zones for the third set of potential delivery locations by the scout autonomous vehicle and archive the still images and videos or data associated with landing zones for use by delivery drones. The scout autonomous vehicle may send information associated with the landing zones for the third set of potential delivery locations back to the central sever to be stored in the database.

In some example embodiments, when locations where a scout autonomous vehicle is required to fly over high altitude pass over potential delivery locations for searching for suitable landing zones, the system may then send out a physical or electronic message to let the customer know their locations look suitable from a high view, and to obtain permission to make a lower altitude inspection.

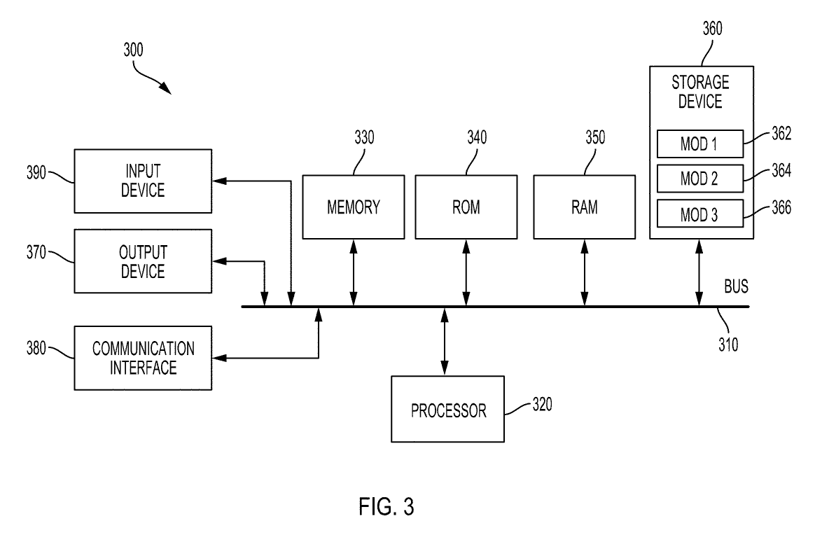

FIG. 3 illustrates an example computer system 300 which can be used to perform the processes for identifying vehicle delivery location utilizing scout autonomous vehicles as disclosed herein. The computing system 300 may be a server, a personal computer (PC), or another type of computing device. The exemplary system 300 can include a processing unit (CPU or processor) 320 and a system bus 310 that couples various system components including the system memory 330 such as read only memory (ROM) 340 and random access memory (RAM) 350 to the processor 320. The system 300 can include a cache of high speed memory connected directly with, in close proximity to, or integrated as part of the processor 320. The system 300 copies data from the memory 330 and/or the storage device 360 to the cache for quick access by the processor 320. In this way, the cache provides a performance boost that avoids processor 320 delays while waiting for data. These and other modules can control or be configured to control the processor 320 to perform various actions. Other system memory 330 may be available for use as well. The memory 330 can include multiple different types of memory with different performance characteristics. It can be appreciated that the disclosure may operate on a computing device 300 with more than one processor 320 or on a group or cluster of computing devices networked together to provide greater processing capability. The processor 320 can include any general purpose processor and a hardware module or software module, such as module 1 362, module 2 364, and module 3 366 stored in storage device 360, configured to control the processor 320 as well as a special-purpose processor where software instructions are incorporated into the actual processor design. The processor 320 may essentially be a completely self-contained computing system, containing multiple cores or processors, a bus, memory controller, cache, etc. A multi-core processor may be symmetric or asymmetric.

The system bus 310 may be any of several types of bus structures including a memory bus or memory controller, a peripheral bus, and a local bus using any of a variety of bus architectures. A basic input/output (BIOS) stored in ROM 340 or the like, may provide the basic routine that helps to transfer information between elements within the computing device 300, such as during start-up. The computing device 300 further includes storage devices 360 such as a hard disk drive, a magnetic disk drive, an optical disk drive, tape drive or the like. The storage device 360 can include software modules 362, 364, 366 for controlling the processor 320. Other hardware or software modules are contemplated. The storage device 360 is connected to the system bus 310 by a drive interface. The drives and the associated computer-readable storage media provide nonvolatile storage of computer-readable instructions, data structures, program modules and other data for the computing device 300. In one aspect, a hardware module that performs a particular function includes the software component stored in a tangible computer-readable storage medium in connection with the necessary hardware components, such as the processor 320, bus 310, display 370, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 300 is a small, handheld computing device, a desktop computer, or a computer server.

Although the exemplary embodiment described herein employs the hard disk 360, other types of computer-readable media which can store data that are accessible by a computer, such as magnetic cassettes, flash memory cards, digital versatile disks, cartridges, random access memories (RAMs) 350, and read only memory (ROM) 340, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 300, an input device 390 represents any number of input mechanisms, such as a microphone for speech, a touch-sensitive screen for gesture or graphical input, keyboard, mouse, motion input, speech and so forth. An output device 370 can also be one or more of a number of output mechanisms known to those of skill in the art. In some instances, multimodal systems enable a user to provide multiple types of input to communicate with the computing device 300. The communications interface 380 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

What is claimed is:

1. A computer-implemented method, comprising:
under control of a computing device configured with executable instructions:
identifying locations having addresses stored at a database;
filtering the locations to identify a first set of delivery locations, the first set of the delivery locations being on or near to an existing or planned drone delivery route;
assigning a confidence level to each of the first set of delivery locations based on clearance status and drone delivery routes;
identifying a second set of delivery locations in high confidence landing zones using a geo-spatial data, the second set of the delivery locations not currently used for a drone delivery program;
instructing a scout autonomous vehicle equipped with a sensor suite to reconnoiter locations of the second set of the delivery locations having a high confidence level, wherein the scout autonomous vehicle is configured to:
record still images and videos of the locations of the second set of the delivery locations;
analyze the still images and videos to determine a third set of delivery locations; and
suggest landing zones at the third set of the delivery locations based on an analysis of the still images and videos.

2. The computer-implemented method of claim 1, wherein filtering the first set locations of the delivery locations further comprising:
analyzing the geo-spatial data associated with existing drone route locations, existing drone route delivery locations, specified radius from a nearest drone hub and
finding intersections of existing routes, delivery locations with low levels of obstructions and near existing drone delivery locations.

3. The computer-implemented method of claim 1, wherein identifying a second set of the delivery locations further comprises:
comparing the assigned confidence level of each of the second set of the delivery locations with a pre-determined confidence level; and
selecting the second set of the delivery locations potentially resided in high confidence landing zones when the confidence level is higher or equal to the pre-determined confidence level, wherein the pre-determined confidence level is defined by a set of criteria associated with a residence suitable for a drone delivery.

4. The computer-implemented method of claim 1, wherein identifying the second set of the delivery locations further comprises analyzing the geo-spatial data associated with at least one of satellite images or other high-resolution image obtained from geo-spatial sources and geographic location data or maps.

5. The computer-implemented method of claim 4, wherein the scout autonomous vehicle comprises on board cameras with both visual and infrared spectra, Lidar sensors, and laser altimeter.

6. The computer-implemented method of claim 1, wherein the sensor suite of the scout autonomous vehicle is configured to pick up obstacles, map out trajectories, and identify the residence suitable for a drone delivery.

7. The computer-implemented method of claim 1, further comprises:
documenting the landing zones for the third set of the delivery locations by the scout autonomous vehicle; and
archiving the still images and videos or data associated with the landing zones for use by delivery drones.

8. The computer-implemented method of claim 1, further comprising sending the still images or videos showing the delivery location to a user.

9. The computer-implemented method of claim 1, wherein the locations associated with the plurality of delivery locations comprise delivery addresses designated to receive ordered items.

10. A system for identifying vehicle delivery locations, comprising:
a scout autonomous vehicle;
a computing device comprising:
at least one computer processor; and
a memory coupled to the processor and storing program instructions that when executed by the processor and based on a sensor detection, cause the processor to perform operations comprising:
identifying locations having addresses stored at a database;
filtering the locations to identify a first set of delivery locations, the first set of the delivery locations being on or near to an existing or planned drone delivery route;
assigning a confidence level to each of the first set of the delivery locations based on clearance status and drone delivery routes;
identifying a second set of delivery locations potentially resided in high confidence landing zones using a geo-spatial data, the second set of the delivery locations not currently used for a drone delivery program;
instructing the scout autonomous vehicle equipped with a sensor suite to reconnoiter locations of the second set of the delivery locations having a high confidence level, the scout autonomous vehicle being configured to:
record still images and videos of the locations of the second set of the delivery locations;
analyze the still images and videos to determine a third set of delivery locations; and
suggest landing zones at locations of the third set of the delivery locations based on an analysis of the still images and videos.

11. The system of claim 10, wherein filtering the first set locations of the delivery locations further comprising:
analyzing, the geo-spatial data associated with existing drone route locations, existing drone route delivery locations, specified radius from a nearest drone hub; and
finding intersections of existing routes, yards with low levels of obstructions and near existing drone delivery locations, to locate the first set of the customers.

12. The system of claim 10, wherein identifying a second set of delivery locations further comprise:
comparing the confidence level of each of the second set of the delivery locations with a pre-determined confidence level; and
selecting the second set of delivery locations potentially resided in high confidence landing zones when the confidence level is higher or equal to the pre-determined confidence level, wherein the pre-determined confidence level is defined by a set of criteria associated with a residence suitable for a drone delivery.

13. The system of claim 10, wherein identifying the second set of the delivery locations further comprising analyzing the geo-spatial data associated with at least one of satellite images or other high-resolution image obtained from geo-spatial sources and geographic location data or maps.

14. The system of claim 10, wherein the scout autonomous vehicle comprises on board cameras with both visual and infrared spectra, Lidar sensors, and laser altimeter.

15. The system of claim 10, wherein the sensor suite of the scout autonomous vehicle is configured to pick up obstacles, map out trajectories, and identify the delivery locations suitable for a drone delivery.

16. The system of claim 10, wherein the operations further comprise:
documenting the landing zones for the third set of the delivery locations by the scout autonomous vehicle; and
archiving the still images and videos or data associated with the landing zones for use by delivery drones.

17. The system of claim 10, wherein the locations associated with the plurality of customers comprise delivery addresses to receive ordered items.

18. A non-transitory computer-readable storage medium having instructions stored which, when executed by a computing device, cause the computing device to perform operations comprising:
identifying locations associated with a plurality of delivery locations having addresses stored at a database;
filtering the locations of the plurality of the delivery locations to identify a first set of the delivery locations, the first set of the delivery locations being on or near to an existing or planned drone delivery route;
assigning a confidence level to each of the first set of the delivery locations based on clearance status and drone delivery routes;
identifying a second set of delivery locations potentially resided in high confidence landing zones using a geo-spatial data, the second set of the delivery locations not currently used for a drone delivery program;
instructing a scout autonomous vehicle equipped with a sensor suite to reconnoiter locations of the second set of the delivery locations having a high confidence level, the scout autonomous vehicle being configured to:
record still images and videos of the locations of the second set of the customers;
analyze the still images and videos to determine a third set of delivery locations; and
suggest landing zones at locations of the third set of the delivery locations based on an analysis of the still images and videos.

19. The non-transitory computer-readable storage medium of claim 18, wherein filtering the first set locations of the delivery locations further comprises:
analyzing, the geo-spatial data associated with existing drone route locations, existing drone route delivery locations, specified radius from a nearest drone hub; and
finding intersections of existing routes, delivery locations with low levels of obstructions and near existing drone delivery locations, to locate the first set of the delivery locations.
